(19) United States
(12) Patent Application Publication
(10) Pub. No.: US 2007/0284988 A1
(43) Pub. Date: Dec. 13, 2007

(54) FLAT ELECTRODE, ULTRA THIN SURFACE LIGHT SOURCE DEVICE AND BACKLIGHT UNIT HAVING THE SAME

(75) Inventors: Kyeong Taek JUNG, Suwon-si (KR); Hyung Bin Youn, Suwon-si (KR); Seok Mo Ban, Suwon-si (KR); Dai Hong Jung, Suwon-si (KR); Ki Yeon Lee, Suwon-si (KR); Keun Seok Lee, Suwon-si (KR); Dong Hee Lee, Suwon-si (KR); Eun Sook Kwon, Suwon-si (KR)

Correspondence Address: BEYER WEAVER LLP, P.O. BOX 70250, OAKLAND, CA, 94612-0250, US

(73) Assignee: SAMSUNG CORNING CO., LTD., Suwon-si (KR)

(21) Appl. No.: 11/684,531

(22) Filed: Mar. 9, 2007

(30) Foreign Application Priority Data
Jun. 12, 2006 (KR) 10-2006-0052729
Jun. 12, 2006 (KR) 10-2006-0052730
Jun. 12, 2006 (KR) 10-2006-0052731
Jun. 12, 2006 (KR) 10-2006-0052732
Jun. 16, 2006 (KR) 10-2006-0054458
Aug. 7, 2006 (KR) 10-2006-0074331

(51) Int. Cl. H01K 1/02

(52) U.S. Cl. 313/326

(57) ABSTRACT

There is provided a flat electrode for a surface light source, in which a conductive electrode is formed in a fine strip-shaped pattern on a plane. The flat electrode may comprise a base layer, an electrode pattern formed on the base layer, and a protection layer formed on the electrode pattern. There is also provided an ultra thin surface light source device which comprises: a first substrate and a second substrate which are spaced apart from each other at a predetermined interval; and a first surface electrode formed on the first substrate, and a second surface electrode formed on the second substrate. The surface light source device may further comprise a medium layer formed in at least one of spaces between the first substrate and the first surface electrode and between the second substrate and the second surface electrode.

### BACKGROUND OF THE INVENTION

1. Technical Field

The present invention relates to a flat electrode and an ultra thin surface light source device and a backlight unit, each having the flat electrode, and more particularly, to a new surface light source device suitable for a mercury free lamp.

2. Discussion of Related Art

A liquid crystal display (LCD) device displays an image, using an electrical characteristic and an optical characteristic of liquid crystal. Since the LCD device is very small in size and light in weight, compared to a cathode-ray tube (CRT) device, it is widely used for portable computers, communication products, liquid crystal television (LCTV) receivers, aerospace industry, and the like.

The LCD device includes a liquid crystal controlling part for controlling the liquid crystal, and a backlight source for supplying light to the liquid crystal. The liquid crystal controlling part includes a number of pixel electrodes disposed on a first substrate, a single common electrode disposed on a second substrate, and liquid crystal interposed between the pixel electrodes and the common electrode. The number of pixel electrodes correspond to resolution, and the single common electrode is placed in opposite to the pixel electrodes. Each pixel electrode is connected to a thin film transistor (TFT) so that each different pixel voltage is applied to the pixel electrode. An equal level of a reference voltage is applied to the common electrode. The pixel electrodes and the common electrode are composed of a transparent conductive material.

The light supplied from the backlight source passes through the pixel electrodes, the liquid crystal and the common electrode sequentially. The display quality of an image passing through the liquid crystal significantly depends on brightness and brightness uniformity of the backlight source. Generally, as the brightness and brightness uniformity are high, the display quality is improved.

In a conventional LCD device, the backlight source generally uses a cold cathode fluorescent lamp (CCFL) in a bar shape or a light emitting diode (LED) in a dot shape. The CCFL has high brightness and long life of use and generates a small amount of heat, compared to an incandescent lamp. The LED has high consumption of power but has high brightness. However, in the CCFL or LED, the brightness uniformity is weak. Therefore, to increase the brightness uniformity, the backlight source, which uses the CCFL or LED as a light source, needs optical members, such as a light guide panel (LGP), a diffusion member and a prism sheet. Consequently, the LCD device using the CCFL or LED becomes large in size and heavy in weight due to the optical members.

Therefore, a flat fluorescent lamp (FFL) has been suggested as the backlight source of the LCD device.

FIG. 1 is a perspective view illustrating an example of a typical surface light source device. Referring to FIG. 1, a conventional surface light source device 100 comprises a light source body 110 and an electrode 160 positioned on the outer surface at both edges of the light source body 110. The light source body 110 includes a first substrate and a second substrate which are positioned in parallel to each other and spaced apart from each other at a predetermined interval. A number of partitioning parts 140 are positioned between the first and second substrates, thereby dividing the space between the first and second substrates into a plurality of discharge channels 120. A sealing member (not shown) is positioned between the edges of the first and second substrates, thereby isolating the discharge channels 120 from the outside. A discharge gas is injected into a discharge space 150 inside each discharge channel.

To discharge the surface light source device, an electrode is applied to both or any one of the first and second substrates, and the electrode has a strip shape or an island shape to have a same area per discharge channel. When the surface light source device is driven by an inverter, all channels of the whole surface are discharged uniformly.

However, in the conventional light source device, since the light-emitting characteristic is different depending on the positions of the discharge channels, the brightness uniformity is not good. Furthermore, a dark region results from a channeling phenomenon by the interference between the adjacent channels among the plurality of the discharge channels.

Specifically, in the conventional surface light source device, since mercury (Hg) is used as the discharge gas, it causes environmental problems. Moreover, when the conventional surface light source device is driven at a low temperature, it takes long time for the brightness to be stabilized. Moreover, since mercury is sensitive to temperature, the brightness uniformity deteriorates by the temperature deviation of a surface light source. Moreover, there are many technical problems to be solved for a large surface light source device.

### SUMMARY OF THE INVENTION

Therefore, the present invention is directed to provide a surface light source device which is suitable to be large in area.

Another object of the present invention is to provide a surface light source device and a backlight unit which have high brightness and brightness uniformity and are thin in thickness.

Another object of the present invention is to provide a surface light source device which is suitable for a mercury free discharge gas.

The other objects and characteristics of the present invention will be presented in detail below.

In accordance with an aspect of the present invention, the present invention provides a flat electrode for a surface light source device, comprising: a conductive electrode part in a strip-shaped electrode pattern including a plurality of electrode elements on a plane.

A pitch between adjoining ones of the electrode elements in the electrode pattern may be in a range of 0.5 to 3 mm. A pitch of the electrode pattern may be in a range of 2 to 3 mm in order to prevent temperature increase. A thickness of the electrode pattern may be in a range of 10 to 500 μm. The flat electrode may comprise a base layer; an electrode pattern formed on the base layer; and a protection layer formed on the electrode pattern.

In another aspect of the present invention, the present invention provides an ultra thin surface light source device comprising: a first substrate; a second substrate spaced apart from the first substrate at a predetermined interval; a first surface electrode part formed on the first substrate, and a second surface electrode part formed on the second substrate; and a medium layer formed in at least one of spaces between the first substrate and the first surface electrode part and between the second substrate and the second surface electrode part.

The medium layer secures the bonding between the surface electrode parts and the substrates, and the interval between the first surface electrode part and the second surface electrode part is controlled depending on the thickness of the medium layer, so that the discharge characteristic and thermal characteristic of the surface light source device are controlled.

In accordance with another exemplary embodiment, the present invention provides an ultra thin surface light source device comprising: a first substrate; a second substrate spaced apart from the first substrate at a predetermined interval; and a first surface electrode part formed on the first substrate, and a second surface electrode part formed on the second substrate. At least one of the first surface electrode part and the second surface electrode part comprises a base layer, an electrode pattern formed on the base layer, and a protection layer formed on the electrode pattern.

The first and second surface electrode parts protect the electrode pattern using the base layer and the protection layer, so that the durability of the electrode pattern is improved, the substrates and the surface electrode parts are easily bonded, and a flat electrode with a large area in a plate or sheet shape is easily formed.

In another aspect of the present invention, the present invention provides an ultra thin backlight unit comprising: a surface light source device including a sealed discharge space formed by a first substrate and a second substrate; a first surface electrode part formed on the first substrate, and a second surface electrode part formed on the second substrate; and a medium layer formed in at least one of spaces between the first substrate and the first surface electrode part and between the second substrate and the second surface electrode part; a case receiving the surface light source device; and an inverter applying a voltage to the first surface electrode part and the second surface electrode part.

At least one of the first surface electrode part and the second surface electrode part may comprise a base layer, an electrode pattern formed on the base layer, and a protection layer formed on the electrode pattern. A medium layer may be formed in at least one of spaces between the first substrate and the first surface electrode part and between the second substrate and the second surface electrode part.

The surface light source device and the backlight unit according to embodiments of the present invention are fabricated in an ultra thin structure in which the entire thickness is very thin. Furthermore, the sealed space formed by the first substrate, the second substrate and the sealing member forms an inner discharge space in a single open structure. A mercury free gas is used as a discharge gas to be injected into the discharge space, so that it is applicable to an environment-friendly product. The discharge space is not divided by partitions, so that the light emitted to the whole surface of the substrates has very excellent brightness and brightness uniformity.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a perspective view illustrating an example of a typical surface light source device;

FIG. 2 is a perspective view illustrating a surface light source device according to an embodiment of the present invention;

FIG. 3 is a side view illustrating the surface light source device according to an embodiment of the present invention;

FIG. 4 is a sectional view taken along line X-X′ of FIG. 2;

FIG. 5 is a partially enlarged view illustrating Part A of FIG. 4;

FIG. 6 is a sectional view illustrating an electrode part in a multilayer structure according to the present invention;

FIGS. 7 through 10 are sectional views illustrating an example of a process of manufacturing the electrode part in the multilayer structure according to the present invention;

FIGS. 11 through 14 are plan views illustrating various examples of an electrode pattern of the electrode part according to the present invention;

FIG. 15 is a partially enlarged plan view illustrating an electrode pattern;

FIG. 16 is a graph illustrating a relation between a pitch of an electrode pattern and a brightness characteristic of the electrode pattern;

FIG. 17 is a sectional view illustrating a surface light source device according to another embodiment of the present invention;

FIG. 18 is a partially enlarged view illustrating Part B of FIG. 17;

FIG. 19 is a plan view of a dual electrode pattern according to another embodiment of the present invention;

FIG. 20 is a partially enlarged view illustrating Part P which is an example of the dual electrode pattern of FIG. 19;

FIG. 21 is a partially enlarged view illustrating Part P which is another example of the dual electrode pattern of FIG. 19;

FIG. 22 is a perspective view of an attachable diffusion layer according to the present invention;

FIG. 23 is a sectional view illustrating a surface light source device including the attachable diffusion layer according to the present invention;

FIG. 24 is a partially enlarged view illustrating Part C of FIG. 11;

FIG. 25 is a perspective view of a spacer-integrated substrate according to the present invention;

FIG. 26 is a partially enlarged view illustrating Part Q of FIG. 25;

FIG. 27 is a sectional view illustrating the integrated spacer and substrate according to the present invention;

FIG. 28 is a sectional view illustrating a surface light source device including a reflecting layer;

FIG. 29 is a sectional view illustrating a surface light source device including no reflecting layer;

FIG. 30 is a perspective view illustrating a reflective flat electrode; and

FIG. 31 is a separate perspective view illustrating a backlight unit including a surface light source device of the present invention.

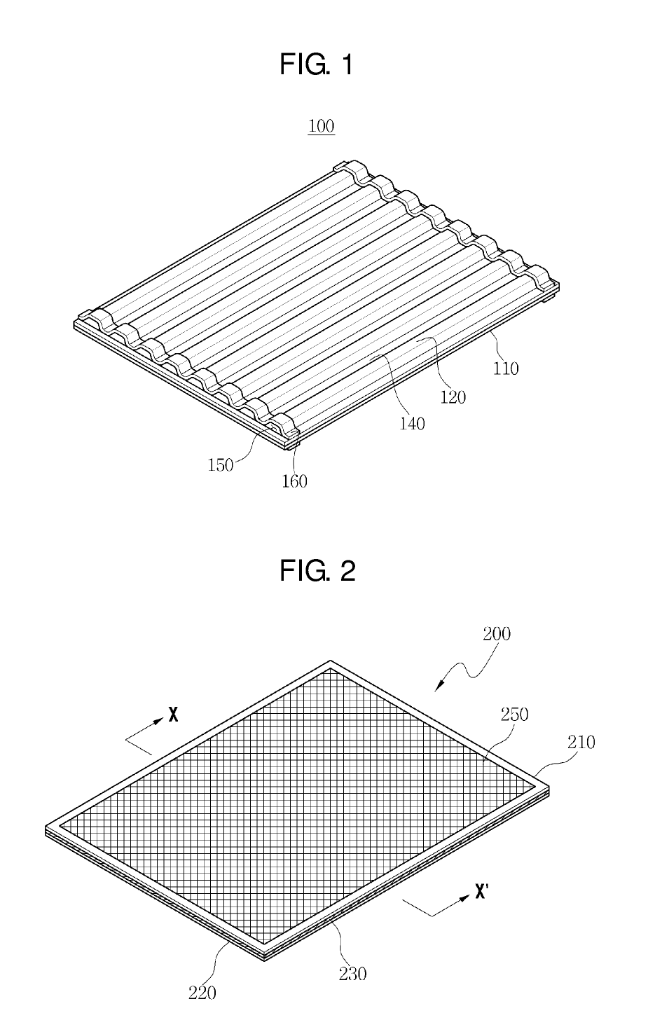

### DETAILED DESCRIPTION OF THE INVENTION

The present invention will now be described more fully hereinafter with reference to the accompanying drawings, in which preferred embodiments of the invention are shown.

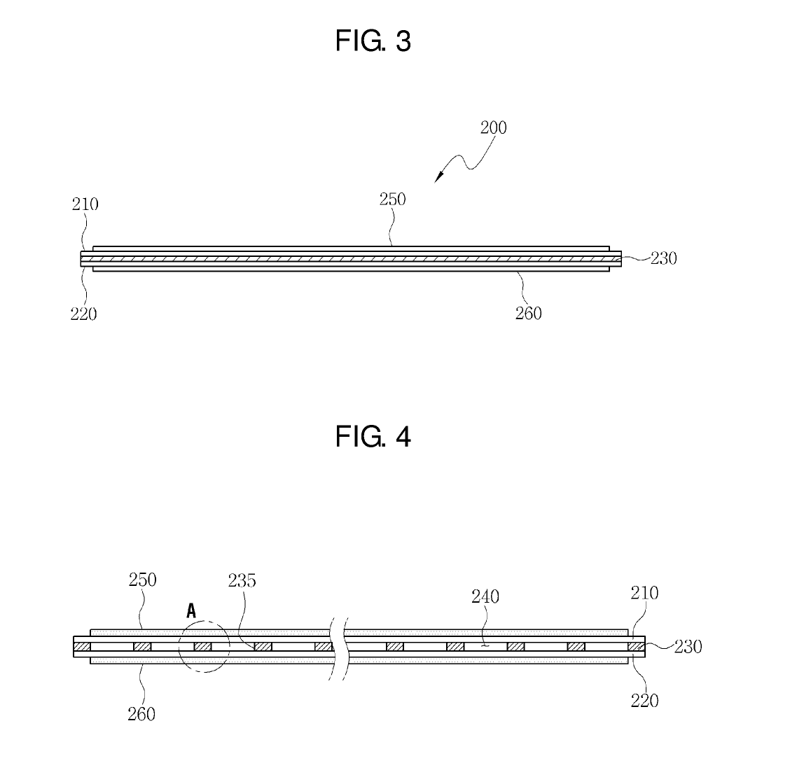

FIG. 2 is a perspective view illustrating a surface light source device 200 according to an embodiment of the present invention, and FIG. 3 is a side view illustrating the surface light source device of FIG. 2.

The surface light source device 200 comprises a first substrate 210 having a flat shape and a second substrate 220 having the same shape as the first substrate 210. The first substrate 210 and the second substrate 220 may be composed of transparent thin and flat glass substrates. Each thickness of the first substrate 210 and the second substrate 220 may be within a range of 1 to 2 mm, and preferably, a thickness of 1 mm or less, but is not restricted thereto.

A fluorescent layer is applied to an inner surface of each of the first substrate 210 and the second substrate 220. A reflective layer may be further formed in either one of the first and second substrates. The first substrate 210 and the second substrate 220 are spaced apart from each other, at a predetermined interval, and positioned in parallel to each other. A sealing member 230, such as a frit, is inserted between the edges of the first substrate 210 and the second substrate 220, thereby forming a sealed space. Alternatively, a sealed space may be formed by locally fusing the edges of the two substrates.

In the surface light source device according to the present invention, a flat electrode having a large area is formed on the outer surface of a light source body formed by the first substrate and the second substrate.

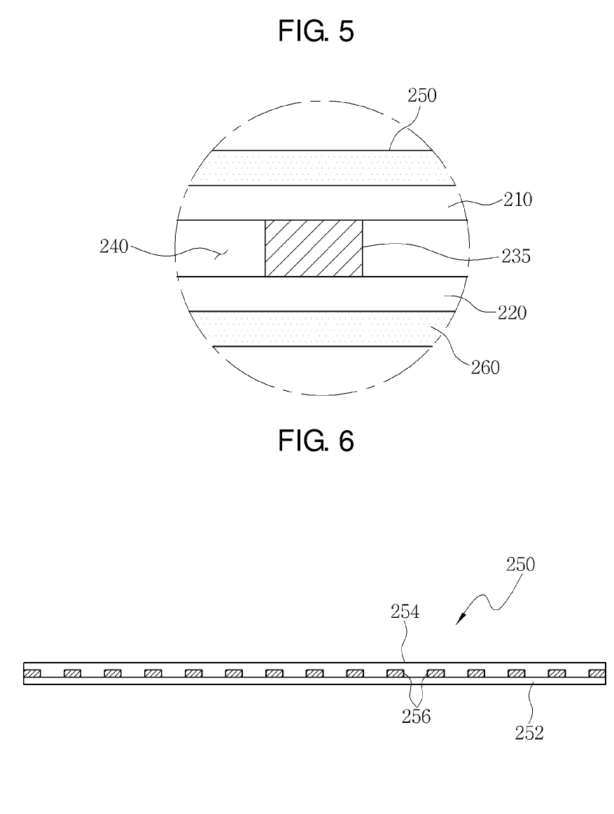

FIG. 4 is a sectional view taken along line X-X′ of FIG. 2, and FIG. 5 is a partially enlarged view illustrating Part A of FIG. 4. As illustrated, a first surface electrode part 250 is formed on the outer surface of the first substrate 210, and a second surface electrode part 260 is formed on the outer surface of the second substrate 220. The first surface electrode part 250 and the second surface electrode part 260 are surface electrodes in a flat shape to substantially cover the whole area of the substrates.

At least one of the first surface electrode part 250 and the second surface electrode part 260 may have a 60% or more open ratio to expose the substrate, in order to increase a transparency of the light emitted by discharge from the light source body.

The first substrate 210 and the second substrate 220 are flat, and the inside which is defined by the first substrate, the second substrate and the sealing member forms a discharge space 240 in a single open structure, unlike independent discharge spaces divided by the partitions in a conventional surface light source device. Since the interval between the first substrate and the second substrate is very small compared to the substrate area, and the inner space is formed as the single open structure, it is very easy to pump for vacuum and to inject a discharge gas. Furthermore, in addition to mercury, xenon, argon, neon or any other inert gases, or a mixture thereof may be suitably used as the discharge gas to constitute the surface light source device.

A vertical height of the discharge space 240 between the first substrate 210 and the second substrate 220 may be determined by a spacer 235. The number of the spacers 235 and the interval between the spacers 235 may be determined within the range in that the brightness characteristic of the light emitted from the surface light source device is not obstructed. A characteristic of the spacer may be artificially added, by molding certain parts of an upper substrate.

Otherwise, the height of the discharge space 240 may be defined by protruding parts (not shown) formed integrally with the inner surface of the first substrate or second substrate.

In the surface light source device according to an embodiment of the present invention, the first surface electrode part 250 and the second surface electrode part 260 may use transparent electrodes (for example, indium tin oxide (ITO)) and may use electrodes in a predetermined pattern.

FIG. 6 is a sectional view illustrating an electrode part according to an embodiment of the present invention. As illustrated in FIG. 6, the electrode part in a multilayer structure comprises a base layer 252 at a lower position, electrode elements 256 formed in a predetermined-shaped electrode pattern on the base layer, and a protection layer 254 formed on the base layer 252 and the electrode elements 256.

When an electrode part includes only the electrode pattern, it is difficult to bond with a glass substrate, and durability is low. However, when the electrode part is formed in the multilayer structure, the electrode parts and the substrates are easily bonded, the durability of the electrode pattern is secured, and the electrode pattern may be formed in various shapes.

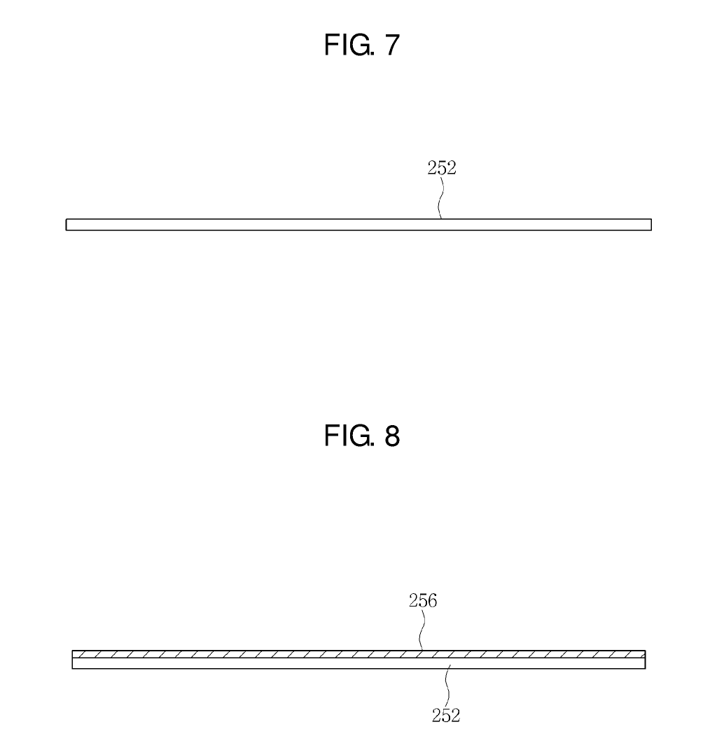

FIGS. 7 through 10 are sectional views illustrating an example of a process of manufacturing the electrode part. A base layer 252 is prepared in a sheet (as shown in FIG. 7), and an electrode material for forming electrode parts in a pattern is applied on the base layer (as shown in FIG. 8). The base layer uses a transparent polymer material which is strong to thermal shock, and the electrode parts may be composed of copper, silver, gold, aluminum, nickel, chrome, high conductive carbon based or polymer based material, or mixtures of these.

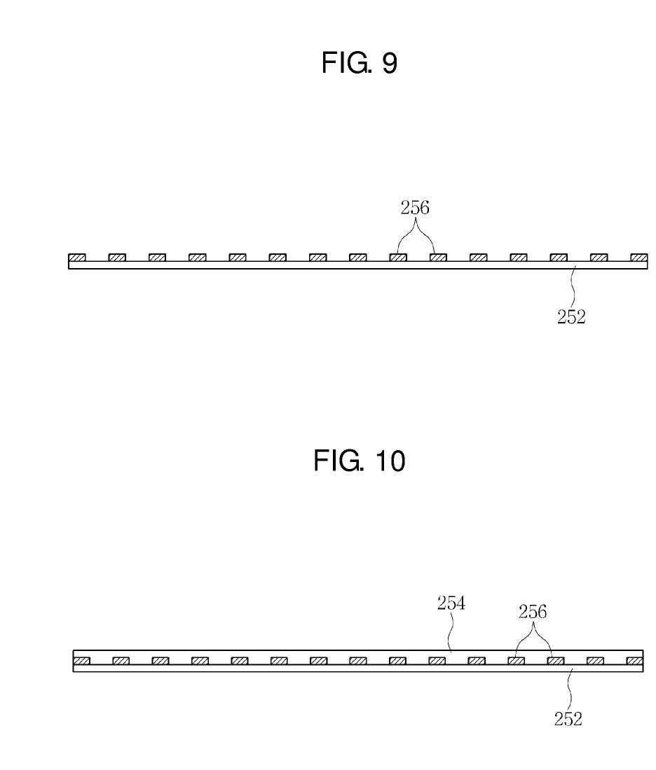

The applied electrode material is patterned in a predetermined shape (as shown in FIG. 9) and a protection layer 254 is additionally formed on electrode elements 256 in a predetermined-shaped pattern (as shown in FIG. 10). The protection layer 254 uses a transparent polymer material which is strong to thermal shock.

The electrode part in the multilayer structure formed in the above-described manner may be attached to first and second substrates after the light source body including the first and second substrates is formed. For example, after a first flat substrate and a second flat substrate are prepared, a fluorescent substance is applied to the inner surfaces of the first and second substrates. A sealing member is formed on the surface of the edge of at least one of the first and second substrates. The first substrate is bonded with the second substrate, to form a sealed discharge space. When the electrode part in the multilayer structure is attached to the outer surface of the first substrate or the second substrate of the light source body as formed, a deformation process is not needed while the light source body is formed. Accordingly, a range of selecting the materials used for the electrode part is broadened, and an increase of the resistance of the electrode part is prevented.

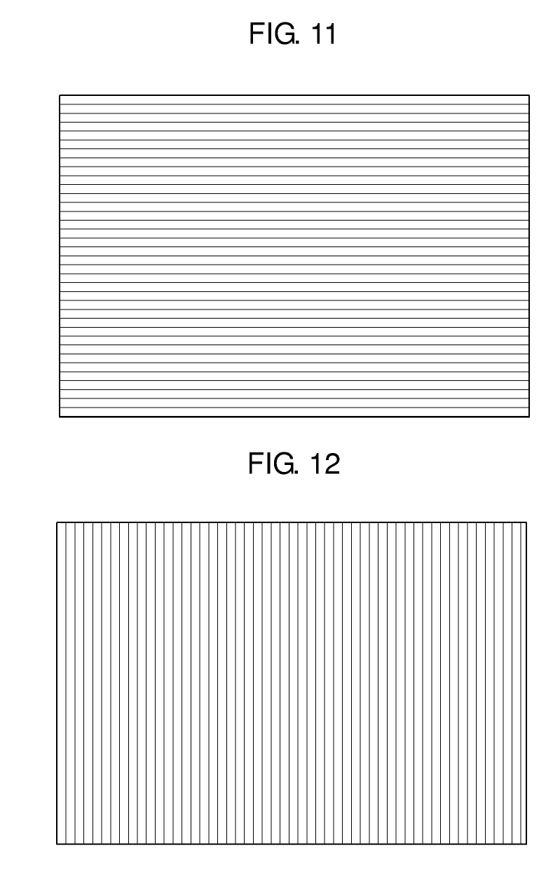

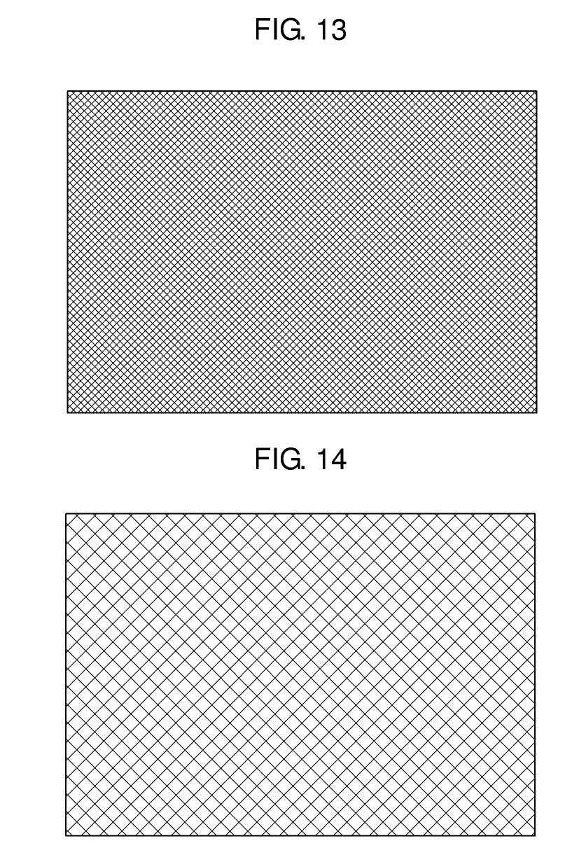

In the flat electrode part used in the surface light source device according to the present invention, the electrode pattern may employ various shapes. For example, the electrode pattern may be formed in a strip shape as illustrated in FIGS. 11 and 12 or in a net shape as illustrated in FIGS. 13 and 14. The first surface electrode part 250 formed on the first substrate 210 and the second surface electrode part 260 formed on the second substrate 220 may have different electrode patterns in shape, thereby changing the discharge characteristic of the surface light source device.

In the flat electrode and the surface light source device including the flat electrode according to the present invention, the inventors of the present invention have found that, the brightness characteristic and the thermal characteristic can be controlled by changing specifically a pitch of the electrode pattern, among the structure of the flat electrode pattern.

In the flat electrode having a patterned structure, an exposure area ratio of the electrode is varied by a change of the width or thickness of the electrode element, or a change of the pitch, i.e., the distance between adjoining ones of the electrode elements in the electrode pattern.

FIGS. 13 and 14 are views illustrating the difference of the exposure ratio in accordance with the difference in the pitch of the electrode pattern.

As illustrated in FIG. 13, when electrode elements in the electrode pattern are more concentrated, the exposure area is relatively reduced, so that the brightness in the surface light source device is decreased. However, as illustrated in FIG. 14, when electrode elements in the electrode pattern are less concentrated to increase the exposure area, the open ratio is increased while the substantial area of the electrode is reduced, so that the discharge characteristic inside the surface light source device is affected.

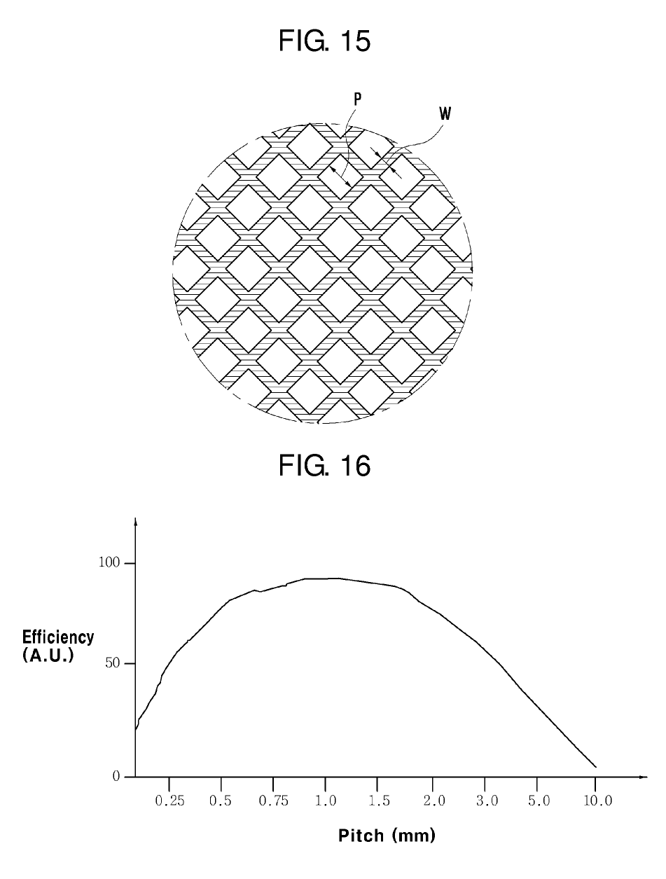

The inventors of the present invention have experimentally confirmed that, in the electrode pattern as illustrated in FIG. 15, the pitch (p) of the electrode pattern rather than the width (w) or thickness of the electrode pattern has more significant effects on the improvement of performance of the surface light source device.

FIG. 16 is a graph illustrating a relation between a pitch of an electrode pattern and a brightness characteristic of the electrode pattern.

Referring to FIG. 16, as a result of observing a change in the brightness efficiency (%) of the surface light source device by varying the pitch of the electrode pattern, it is found that there is a close correlation between the pitch of the electrode pattern and the brightness efficiency. As the pitch is small, the open ratio is reduced so that the brightness is decreased. However, the brightness which is increased as the pitch increases is decreased passing a certain value. This result is because the substantial area of the electrode is reduced as the pitch of the electrode pattern is increased, and accordingly an amount of discharge inside the surface light source device is decreased.

Accordingly, it is known than an appropriate pitch to maintain the brightness of the surface light source device at a predetermined level or more, for example, to maintain the brightness efficiency of 80% required in an LCD-TV, is in a range of about 0.5 to 3 mm, as illustrated in the graph of FIG. 16.

As the pitch of the electrode pattern is smaller, it is favorable in brightness but it may deteriorate the operation characteristic of the surface light source device due to excessive heat generated in the electrode. The inventors of the present invention have conducted the search for the relation between the pitch of the electrode pattern and the temperature resulted from the electrode. As a result, it is confirmed that when the pitch is in a range of 2 to 3 mm, the temperature is relatively decreased by about 20%.

Consequently, in the surface light source device in which overheating needs to be prevented, it is very proper to maintain the pitch of the electrode pattern in the flat electrode according to the present invention within the above-described range.

It is also confirmed that, the thickness of the conductive pattern in the flat electrode of the surface light source device according to the present invention has an effect on the brightness characteristic and the open ratio, and for this purpose, the thickness may be within a range of 10 to 500 μm.

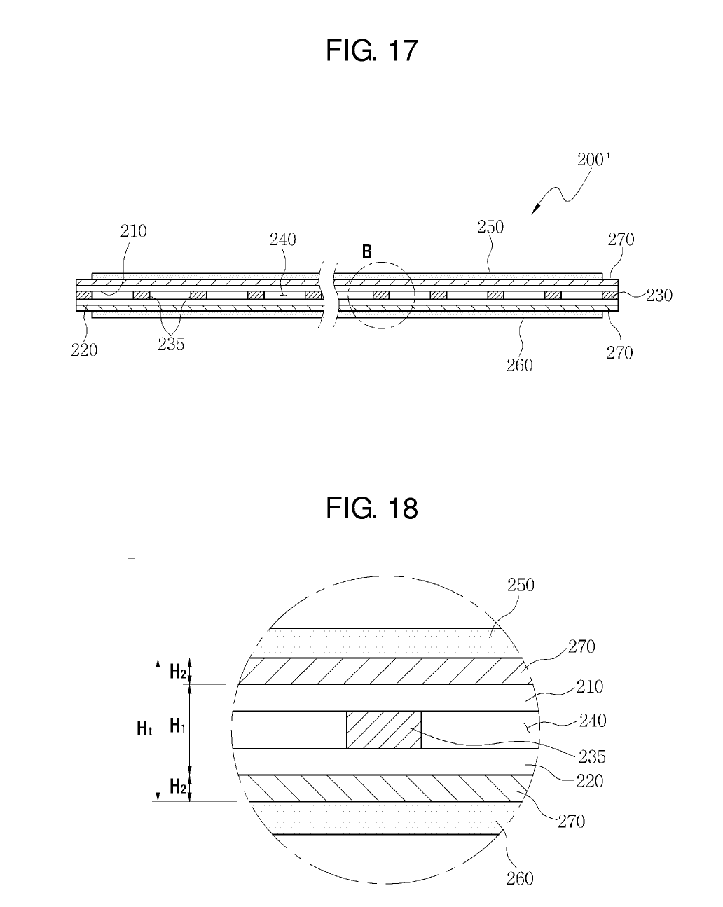

FIG. 17 is a sectional view illustrating an ultra thin surface light source device 200′ according to another embodiment of the present invention, and FIG. 18 is a partially enlarged view illustrating Part B of FIG. 17.

Unlike the embodiment described above, the ultra thin surface light source device further comprises a medium layer 270 between an outer surface of a light source body, which includes a first substrate 210 and a second substrate 220, and an electrode part 250, and another medium layer 270 between the outer surface of the light source body and an electrode part 260.

The medium layer 270 may use a transparent polymer material which has high transparency, specifically, with respect to a visible light and which is strong in mechanical impact resistance, thermal stability and thermal shock. The medium layer may be composed of a polymer of one or more ethylenically unsaturated monomers selected from the group consisting of acrylic acid, methacrylic acid, butyl acrylate, methyl methacrylate, 2-ethylhexyl acrylate, acrylic acid ester, styrene, vinyl ether, vinyl, vinylidene halide, N-vynyl pyrrolidone, ethylene, C3 or more alpha-olefin, allyl amine, saturated monocarboxylic acid, and allyl ester of amide thereof, propylene, 1-butene, 1-pentene, 1-hexene, 1-decene, allyl amine, allyl acetate, allyl propionate, allyl lactate, amides thereof, mixtures of these, 1,3-butadiene, 1,3-pentadiene, 1,4-pendtadiene, cyclopentadiene and hexadiene isoform; or a pressure sensitive adhesive composition including an aqueous emulsified latex system which includes an effective amount of a water-soluble protective colloid for stabilizing the latex system wherein the colloid has a molecular weight less than about 75,000 and is selected from the group consisting of carboxymethyl cellulose of which the lowest degree of substitution for carboxyl is about 0.7 and derivatives thereof, hydroxylethyl cellulose, ethyl hydroxylethyl cellulose, methyl cellulose, methyl hydroxylpropyl cellulose, hydroxylpropyl cellulose, poly(acrylic acid) and alkali metal salt thereof, ethoxylated starch derivatives, sodium and other alkali metal polyacrylate, water-soluble starch glue, gelatin, water-soluble alginate, casein, agar, natural and synthetic gum, partially and wholly hydrolyzed poly(vinyl alcohol), polyacrylamide, poly(vinyl pyrrolidone), poly(methyl vinylether-maleic anhydride), guar and derivatives thereof.

The medium layer is formed at a thickness in a range of 10 μm to 3 mm, and may be formed at least between the first substrate 210 and the first surface electrode part 250 or between the second substrate 220 and the second surface electrode part 260. The thickness of the medium layer is appropriately controlled so as to control the interval between the first surface electrode part 250 and the second surface electrode part 260. For example, as illustrated in FIG. 18, the first distance H1 between the electrode parts, which may be determined by the first substrate 210 and the second substrate 220, may be increased to Ht by the thickness H2 of the medium layer 270. As a result, the interval between the electrode parts is controlled, thereby changing the discharge characteristic and efficiency of the surface light source device.

Furthermore, since the medium layer 270 is interposed between the first substrate 210 and the first electrode part 250 and between the second substrate 220 and the second electrode part 260, the adhesive strength between the substrates and the electrode parts increases. Instead of the electrode parts in the multilayer structure according to the embodiment described above, electrode parts including only an electrode pattern may be used.

Furthermore, the heat generated in the electrode parts 250 and 260 is efficiently controlled by changing the materials and thickness of the medium layer.

The characteristics and detailed structure of the surface light source device including the medium layer 270 may further include the characteristics of the surface light source device with the electrode parts in the multilayer structure as described above, and no further explanation thereof will be presented.

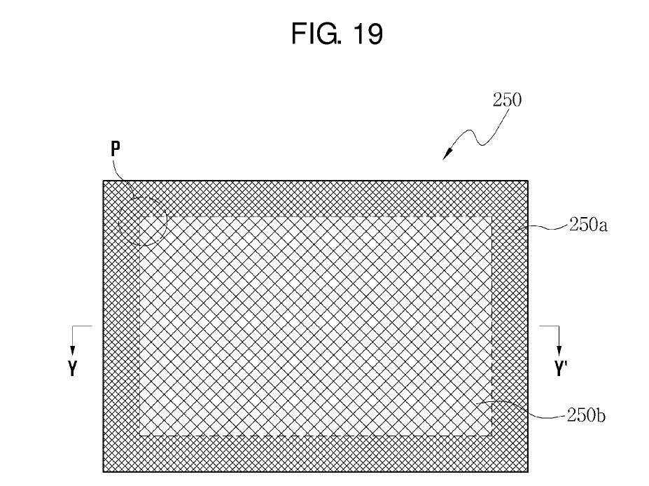

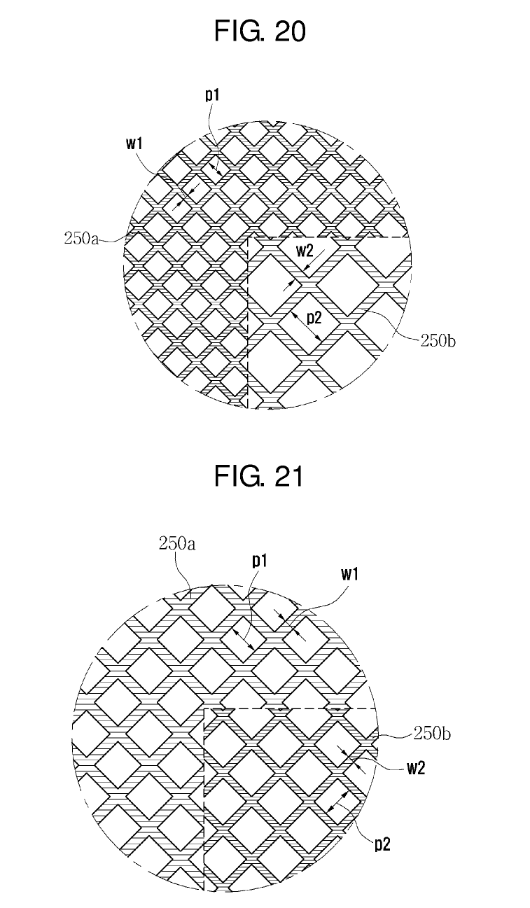

FIG. 19 is a plan view illustrating a detailed structure of a dual electrode pattern of the flat electrode part according to another embodiment of the present invention. The first surface electrode part 250 will be described for clarity but the second surface electrode part may be applicable. As illustrated, the electrode pattern of the electrode part is divided into a first region 250a and a second region 250b. The first region 250a is positioned at an outer edge of the electrode part 250 and the second region 250b is positioned at an inner middle of the electrode part 250. This dual electrode pattern differentiates the light-emitting characteristics depending on the position of the surface light source device, thereby improving the light-emitting efficiency, specifically, nearby the edge of the surface light source device. FIG. 20 is a partially enlarged view illustrating Part P of FIG. 19. A line width w1 of an electrode element in the electrode pattern and a pitch p1 of adjoining electrode elements in the electrode pattern in the first region 250a are respectively smaller than a line width w2 and a pitch p2 of the electrode pattern in the second region 250b. That is, a density of the electrode elements in the electrode pattern (hereinafter, referred to as ‘electrode density’) is differentiated in the first area and the second area by differently designing the electrode patterns. FIG. 21 shows the electrode density being differentiated, according to another embodiment of the present invention. In FIG. 21, a pitch p1 of the first region 250a is equal to a pitch p2 of the second region 250b. However, a line width w1 of the first region 250a is different from a line width w2 of the second region 250b. That is, the electrode density is differentiated in the first region and the second region by differentiating only their respective line widths. Otherwise, the electrode density may be differentiated by differentiating the pitch in the electrode pattern of each electrode region.

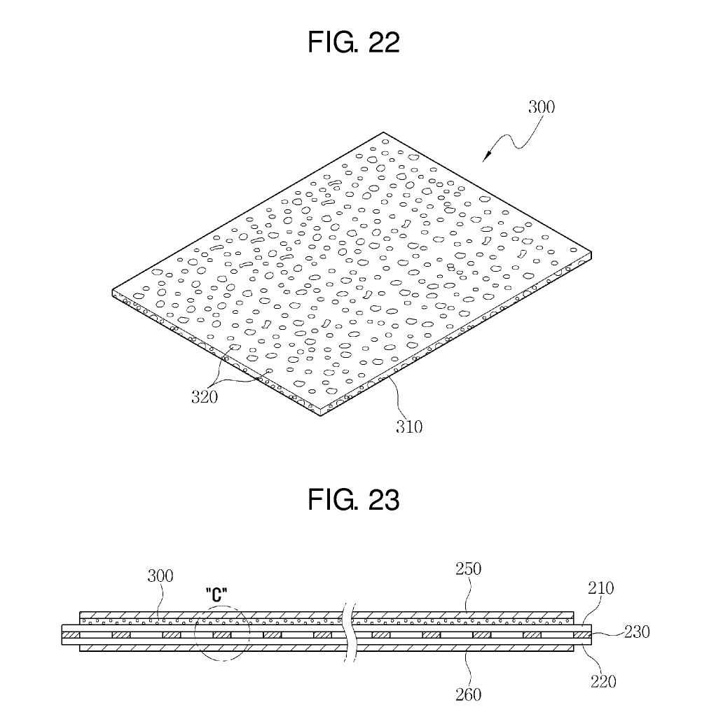

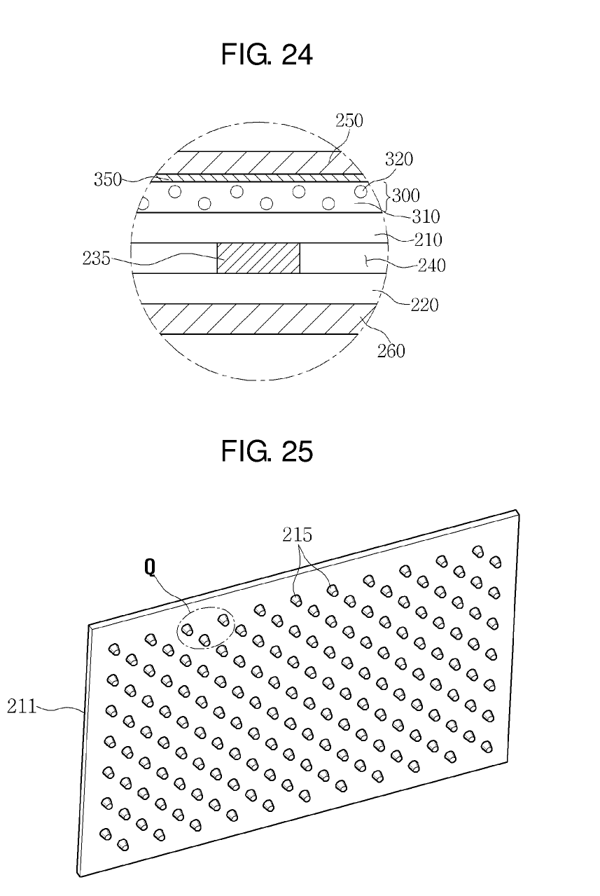

The surface light source device according to the present invention may further comprise a diffusion layer, to reduce a dark region unavoidably caused in a surface light source device and to improve the whole brightness characteristic. In the present invention, the diffusion layer is not included as a separate element like a diffusion member of a conventional backlight unit. In the present invention, the diffusion layer is directly attached to the surface light source device, to be an integrated diffusion layer. As illustrated in FIG. 22, a diffusion layer 300 may have a mixed structure in which glass beads 320 composed of organic or inorganic diffusion material are dispersed in a resin layer 310. The resin layer functions as a matrix of the glass beads composed of the organic or inorganic diffusion material, and the glass beads composed of the organic or inorganic diffusion material are evenly dispersed on the resin layer. The dimensions or quantity of the glass beads composed of the organic or inorganic diffusion material may be optimized, considering the light-emitting efficiency of the surface light source device. FIG. 23 shows the section of the surface light source device being integrated with the diffusion layer. In this embodiment, the diffusion layer 300 is formed on the top surface of the first substrate 210 from which a light is emitted. The first surface electrode part 250 is formed on the diffusion layer 300. The glass beads 320, composed of the organic or inorganic diffusion material, in the diffusion layer 300 improve the brightness uniformity of the surface light source device, by promoting the diffusion and dispersion of the light emitted from the surface light source device. Specifically, the glass beads 320 maximize the light-emitting efficiency by reducing the dark region unavoidably generated. Further, the glass beads 320 reduce the volume of the backlight unit because any additional diffusion member is not needed. As illustrated in FIG. 24, an adhesive layer 350 is formed on the bottom surface of the first surface electrode part 250. The adhesive layer 350 makes a firmer connection with the diffusion layer 300. Pressure sensitive adhesive (PSA) resin may be used as the adhesive layer. In the present invention, a mixed structure, in which the diffusion layer with the organic or inorganic diffusion material being dispersed in the resin matrix is attached to one surface of the electrode layer, may be applied to the light source body of the surface light source. In this case, the adhesive layer may be further included on the one surface of the electrode layer. The structure of the electrode layer may be in the multilayer structure including the base layer, the electrode pattern and the protection layer as described above.

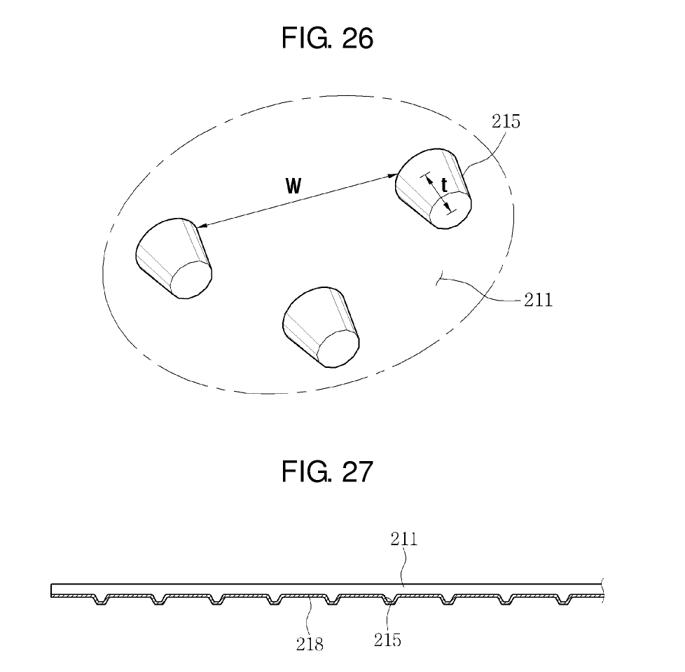

FIG. 25 is a perspective view of an integrated spacer and substrate 211 according to another embodiment of the present invention. In FIG. 25, a plurality of protrusions 215 functioning as a spacer are formed in one body with the substrate 211. Likewise, the protrusions 215 functioning as the spacer may be formed on the other opposite substrate, which will be described later, to the substrate 211. In FIG. 26, the plurality of protrusions 215 formed in one body with the substrate are spaced apart from one another, at the same interval w. The protrusions may vary in shape, number and interval, depending on surface light source devices. Since the light emission is obstructed at the parts where the protrusions are positioned, preferably, the number of protrusions may be less if possible. Preferably, the interval between the protrusions may be maximally great within the scope of not obstructing the pump for vacuum and the injection of a discharge gas in the discharge spaces of the surface light source device. The thickness t of protrusions 215 determines the space between the two substrates forming the discharge spaces of the surface light source device and therefore determines the height of the discharge spaces. The integrated spacer and substrate according to the present invention is capable of determining the height or thickness of the discharge spaces by itself, so that mass productivity is increased and the discharge characteristic is improved. Further, as illustrated in FIG. 27, a fluorescent substance 218 may be coated on the surface of each protrusion 215 formed from the inside of the integrated spacer and substrate 211.

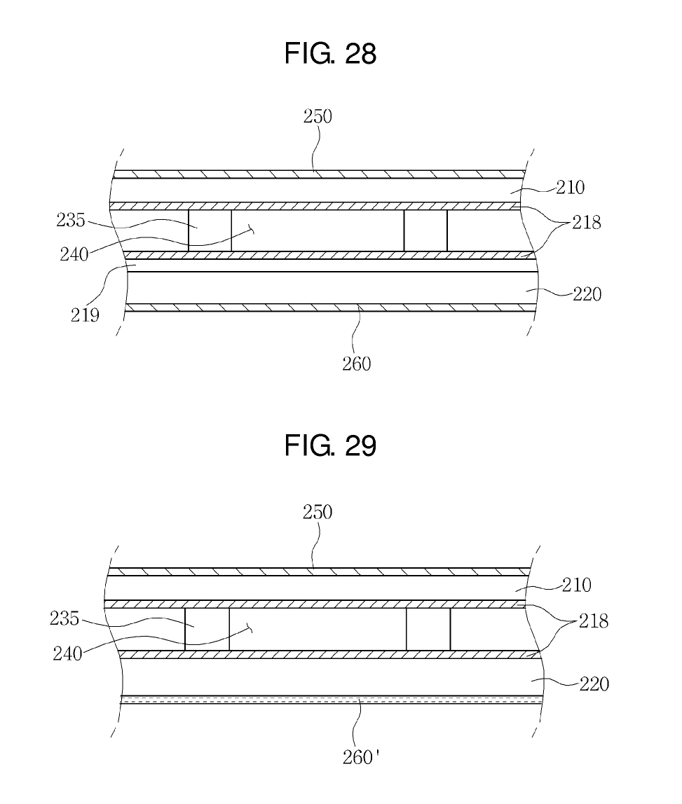

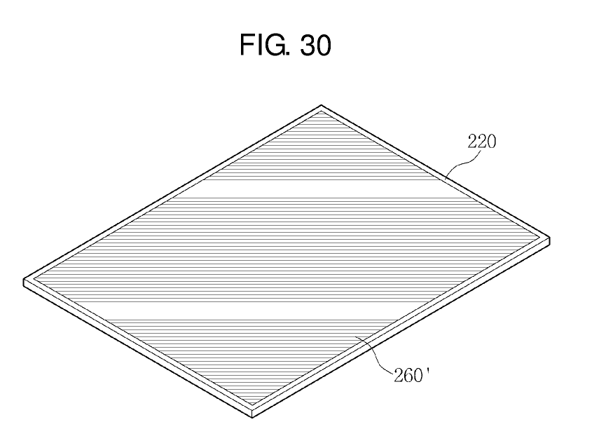

Typically, in a light source for backlight, any one of the first substrate and the second substrate acts as a surface from which a light generated in the discharge space is emitted. On the other substrate, a reflecting layer, composed of Al₂O₃, TiO₂, BaTiO₃ or the mixture of these, is formed to prevent the light from being externally lost. As illustrated in FIG. 28, in the surface light source device, the first substrate 210 is the light-emitting surface, and the second substrate 220 includes a reflecting layer 219 so that the generated light is prevented from being externally lost through the second substrate. However, the velocity of light is somewhat externally lost through the reflecting layer. Meanwhile, a process of forming the reflecting layer on the substrate increases the cost for manufacturing the surface light source device, and it is difficult to select a suitable material used for the reflecting layer. In accordance with another embodiment of the present invention, there is provided an additional advantage in that a flat electrode is formed on the back surface of the substrate, so as to function as the reflecting layer. In FIG. 29, the fluorescent substance 218 is applied to the inner surface of the first substrate 210 and the second substrate 220 in which no reflecting layer is included. The first surface electrode part 250 is formed on the top surface of the first substrate 210, and another flat electrode 260′ in a different shape from the first surface electrode part is formed on the bottom surface of the second substrate 220. FIG. 30 illustrates the flat electrode 260′. The flat electrode 260′ substantially covers the entire surface of the second substrate 220 and has a very low open ratio, so that the light generated in the discharge spaces are prevented from being transmitted. From a different standpoint, in the surface light source device according to the embodiment of the present invention, the surface electrode part is formed on the whole outer surface of the first substrate 210 and the reflecting layer is formed on the outer surface of the second substrate 220. The surface light source device in which no reflecting layer is formed is constituted by the first surface electrode part and the second surface electrode part which is significantly lower, in the open ratio, than the first surface electrode part. Therefore, the surface light source device according to the present invention comprises one outer surface electrode and one outer reflecting layer. In this case, the outer reflecting layer may be formed in a pattern with a significantly lower open ratio than the opposite outer surface electrode. That is, the outer reflecting layer may be substantially zero in the open ratio of exposing the substrate. A material of the electrode may use Al, Cu, Ag, Ni, Cr, ITO, carbon-based conductive material or polymer material, or mixtures of these so that the flat electrode 260′ functions as the reflective layer. To have the conductivity and the reflectivity, the flat electrode 260′ may be formed in a thin tape or fine thin-film shape without a leakage region. However, the flat electrode 260′ may be formed in a regular shape, such as a net shape, a strip shape, a circle, an oval or a polygon. For example, a thin metal tape composed of Cu, Al, and the like may be attached to the back surface of the substrate. Otherwise, the reflective flat electrode 260′ may be formed by using a well-known thin-film forming process.

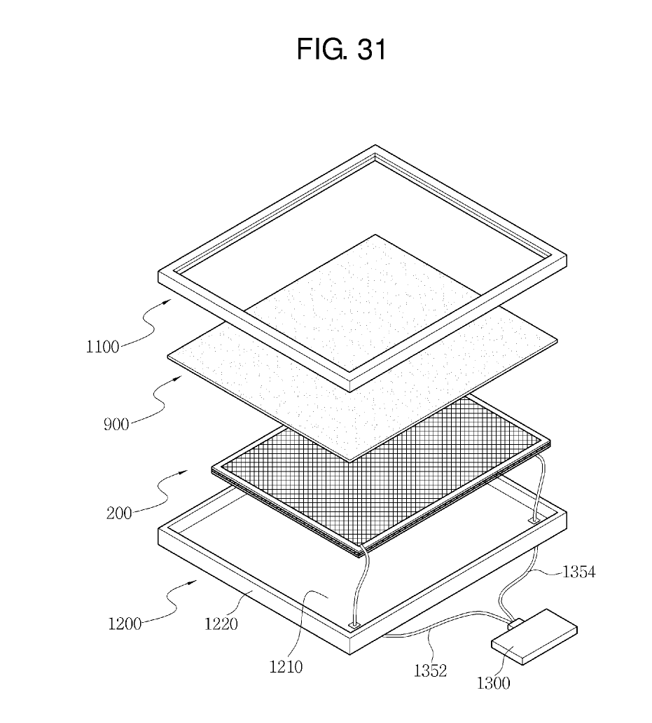

FIG. 31 is a separate perspective view illustrating a backlight unit 1000 including the surface light source device according to the embodiment of the present invention. As illustrated, the backlight unit 1000 comprises a surface light source device 200, upper and lower cases 1100 and 1200, an optical sheet 900 and an inverter 1300. The lower case 1200 is formed of a bottom part 1210 to receive the surface light source device 200, and a plurality of sidewall parts 1220 which are extended to form a receiving space from the edge of the bottom part 1210. The surface light source device 200 is received in the receiving space of the lower case 1200.

The inverter 1300 is positioned at the rear surface of the lower case 1200 and generates a discharge voltage to drive the surface light source device 200. The discharge voltage generated from the inverter 1300 is applied to the electrode parts of the surface light source device 200 through first and second power lines 1352 and 1354, respectively. The optical sheet 900 may include a diffusion plate for uniformly diffusing the light emitted from the surface light source device 200, and a prism sheet for applying linearity to the diffused light. The upper case 1100 is connected to the lower case 1200 and supports the surface light source device 200 and the optical sheet 900. The upper case 1100 prevents the surface light source device 200 from leaving from the lower case 1200.

The upper case 1100 and the lower case 1200 illustrated in FIG. 19 are separated from each other, but they may be formed in a single case. The backline unit according to the present invention may not include the optical sheet 900 because the brightness and brightness uniformity of the surface light source device are high.

The present invention provides the surface light source device in an ultra thin structure and the backlight unit. The inside of the surface light source device forms one single open discharge space. A mercury free gas is used as the discharge gas to be injected into the discharge space, so that it is applicable to environment-friendly products. Further, since the discharge space is not divided by partitions, the brightness and brightness uniformity of the light emitted to the whole surface of the substrates are very high. Furthermore, the adhesive strength between the electrode parts and the substrates is improved, and mass productivity is high.

The invention has been described using preferred exemplary embodiments. However, it is to be understood that the scope of the invention is not limited to the disclosed embodiments. On the contrary, the scope of the invention is intended to include various modifications and alternative arrangements within the capabilities of persons skilled in the art using presently known or future technologies and equivalents. The scope of the claims, therefore, should be accorded the broadest interpretation so as to encompass all such modifications and similar arrangements.

1. A flat electrode for a surface light source device, comprising:
a conductive electrode part in a strip-shaped electrode pattern including a plurality of electrode elements on a plane, a pitch between adjoining ones of the electrode elements in the electrode pattern being in a range of 0.5 to 3 mm.

2. The flat electrode of claim 1, wherein a pitch of the electrode pattern is in a range of 2 to 3 mm.

3. The flat electrode of claim 1, wherein a thickness of the electrode pattern is in a range of 10 to 500 μm.

4. The flat electrode of claim 1, wherein the electrode part comprises a first region and a second region which are different from each other in the density of the electrode pattern.

5. The flat electrode of claim 4, wherein the first region and the second region are different from each other in the pitch or width of the electrode element in the electrode pattern.

6. An ultra thin surface light source device comprising:
a first substrate;
a second substrate spaced apart from the first substrate at a predetermined interval;
a first surface electrode part formed on the first substrate, and a second surface electrode part formed on the second substrate; and
a medium layer formed in at least one of spaces between the first substrate and the first surface electrode part and between the second substrate and the second surface electrode part.

7. The surface light source device of claim 6, wherein the medium layer is transparent with respect to a visible light.

8. The surface light source device of claim 6, wherein a thickness of the medium layer is in a range of 10 μm to 3 mm.

9. The surface light source device of claim 6, wherein the medium layer is composed of a polymer of ethylenically unsaturated monomers or a pressure sensitive adhesive.

10. The surface light source device of claim 6, wherein at least one spacer is interposed between the first substrate and the second substrate.

11. The surface light source device of claim 6, wherein at least one of the first surface electrode part and the second surface electrode part comprises a base layer; an electrode pattern formed on the base layer; and a protection layer formed on the electrode pattern.

12. An ultra thin surface light source device comprising:
a first substrate;
a second substrate spaced apart from the first substrate at a predetermined interval; and
a first surface electrode part formed on the first substrate, and a second surface electrode part formed on the second substrate,
wherein at least one of the first surface electrode part and the second surface electrode part comprises a base layer, an electrode pattern formed on the base layer, and a protection layer formed on the electrode pattern.

13. The surface light source device of claim 12, wherein the base layer and the protection layer are transparent with respect to a visible light.

14. The surface light source device of claim 12, wherein the electrode pattern has a regular shape of a circle, an oval or a polygon, a net shape, or a strip shape.

15. The surface light source device of claim 12, wherein the electrode in the electrode pattern is composed of one material of copper, silver, gold, aluminum, ITO, nickel, chrome, carbon based conductive substance, conductive polymer, and mixtures thereof.

16. The surface light source device of claim 12, wherein at least one of the first surface electrode part and the second surface electrode part has a 60% or more open ratio to expose the first substrate or the second substrate.

17. The surface light source device of claim 6 or claim 12, wherein the first substrate and the second substrate form an inner discharge space in a single open structure, and a mercury free discharge gas is injected into the discharge space.

18. The surface light source device of claim 6 or claim 12, wherein the first surface electrode part or the second surface electrode part comprises a conductive electrode in a strip-shaped pattern including a plurality of electrode elements on a plane, and a pitch between adjoining ones of the electrode elements in the electrode pattern is in a range of 0.5 to 3 mm.

19. The surface light source device of claim 18, wherein a pitch of the electrode pattern is in a range of 2 to 3 mm.

20. The surface light source device of claim 18, wherein a thickness of the electrode pattern is in a range of 10 to 500 μm.

21. The surface light source device of claim 6, further comprising:
a diffusion layer to be attached to the first substrate or second substrate from which the light is emitted.

22. The surface light source device of claim 21, wherein the diffusion layer has a mixed structure in which organic or inorganic diffusion materials are dispersed in a resin matrix.

23. The surface light source device of claim 6, further comprising:
a number of protrusions formed in one body with the inner surface of at least one of the first substrate and the second substrate.

24. The surface light source device of claim 6, wherein the surface electrode part is a reflective electrode formed of a thin metal tape or a metal deposited layer.

25. An ultra thin backlight unit comprising:
a surface light source device including a sealed discharge space formed by a first substrate and a second substrate; a first surface electrode part formed on the first substrate, and a second surface electrode part formed on the second substrate; and a medium layer formed in at least one of spaces between the first substrate and the first surface electrode part and between the second substrate and the second surface electrode part;
a case receiving the surface light source device; and
an inverter applying a voltage to the first surface electrode part and the second surface electrode part.

26. The backlight unit of claim 25, wherein at least one of the first surface electrode part and the second surface electrode part comprises a base layer, an electrode pattern formed on the base layer, and a protection layer formed on the electrode pattern.

27. The backlight unit of claim 25, wherein the first surface electrode part or the second surface electrode part comprises a conductive electrode in a strip-shaped pattern including a plurality of electrode elements on a plane, and a pitch between adjoining ones of the electrode elements in the electrode pattern is in a range of 0.5 to 3 mm.

28. The surface light source device of claim 12, further comprising:
a diffusion layer to be attached to the first substrate or second substrate from which the light is emitted.

29. The surface light source device of or claim 12, further comprising:
a number of protrusions formed in one body with the inner surface of at least one of the first substrate and the second substrate.

30. The surface light source device of or claim 12, wherein the surface electrode part is a reflective electrode formed of a thin metal tape or a metal deposited layer.
